(19) United States
(12) Patent Application Publication
(10) Pub. No.: US 2006/0033722 A1
(43) Pub. Date: Feb. 16, 2006

(54) Structure and mechanism for power-saving of a capacitive touchpad

(76) Inventors: Yen-Chang Chiu, Linkou Shiang (TW); Yung-Lieh Chien, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/190,927

(22) Filed: Jul. 28, 2005

(30) Foreign Application Priority Data
Aug. 13, 2004 (TW) 093124482

(51) Int. Cl. G09G 5/00

(52) U.S. Cl. 345/173

(57) ABSTRACT

For power saving, a structure of a capacitive touchpad comprises a soft board having a bottom surface with a first conductor thereon, a printed circuit board having a top surface with a second conductor thereon, a flexible insulator between the soft board and printed circuit board, and a control circuit having an I/O port connected to the second conductor, such that a pressing on the soft board may move the first conductor down to contact the second conductor to thereby generate a voltage change signal present on the I/O port, causing the control circuit to wake up the capacitive touchpad.

### FIELD OF THE INVENTION

The present invention is related generally to a capacitive touchpad and more particularly to a structure and mechanism for power saving of a capacitive touchpad.

### BACKGROUND OF THE INVENTION

Touchpad has been widely used in various electronic products for providing a simple, light and low-cost input device. Three current types of touchpad are resistive, electromagnetic and capacitive, among which the capacitive touchpad is operated based on the principle of generating an instant capacitive effect resulted from a touch of a user's finger(s) or a conductor on the touchpad to determine the position where the finger(s) or conductor touches in accordance with the change in capacitance. However, it is hard to reduce the power consumption of a capacitive touchpad, since the change in capacitance is constantly scanned no matter the touchpad is in use or not.

Accordingly, it is desired a novel structure of a capacitive touchpad and a mechanism using the structure for reducing the power consumption of the capacitive touchpad.

### SUMMARY OF THE INVENTION

One object of the present invention is to provide a structure and mechanism for power saving of a capacitive touchpad.

In a structure of a capacitive touchpad for power-saving of the capacitive touchpad, according to the present invention, a soft board has a bottom surface with a first conductor thereon, a printed circuit board has a top surface with a second conductor thereon, a flexible insulator is between the soft board and printed circuit board, and a control circuit has an Input/Output (I/O) port connected to the second conductor. When the capacitive touchpad is not in use, it is switched to a power-saving mode. When the soft board is pressed under the power-saving mode, the first conductor will move down to contact the second conductor to result in a voltage change signal present on the I/O port, thereby waking up the capacitive touchpad.

### BRIEF DESCRIPTION OF DRAWINGS

These and other objects, features and advantages of the present invention will become apparent to those skilled in the art upon consideration of the following description of the preferred embodiment of the present invention taken in conjunction with the accompanying drawing, in which:

FIG. 1 shows a structure and mechanism for power saving of a capacitive touchpad according to the present invention.

### DETAILED DESCRIPTION OF THE INVENTION

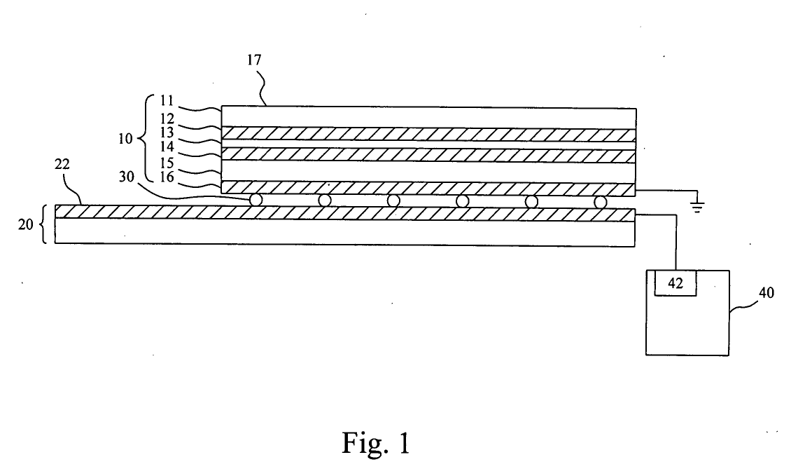

A structure and mechanism for power-saving of a capacitive touchpad according to the present invention are illustrated by FIG. 1, in which a soft board 10 includes a soft plate 17 that is processed to form a sandwich composed of insulator layer 11, conductor layer 12, insulator layer 13, conductor layer 14, insulator layer 15, and conductor layer 16 interlaced with one another, a printed circuit board 20 has a layer of conductor 22 on the top surface thereof, a flexible insulator 30 is between the soft board 10 and printed circuit board 20, and a control circuit 40 has an I/O port 42 connected to the conductor 22. In the soft board 10, the conductor layers 12 and 14 constitute a sensor of the touchpad, for example formed with X and Y traces thereof as a typical capacitive touchpad, and the conductor layer 16 is positioned on the bottom surface of the soft board 10 to serve as a ground plane and preferably comprises a mesh pattern thereof. The flexible insulator 30 may be a layer of filler or comprise fine pieces. The conductor 22 on the printed circuit board 20 faces to the conductor layer 16 of the soft board 10 and is generally made of copper foil. The control circuit 40 employs a conventional port-changed mechanism to monitor the I/O port 42. When the capacitive touchpad is not in use, it is switched from a normal operational mode to a power-saving mode such that all circuits thereof, except for a port-changed detection circuit, are shut down and therefore it consumes extremely low power. In the power-saving mode, the soft board 10 is floating regarding to the printed circuit board 20 since the touchpad is not operated. When a user is to operate the capacitive touchpad, his finger(s) will presses on the soft board 10, which will move the conductor layer 16 of the soft board 10 down to contact the conductor 22 on the printed circuit board 20, and thereby a voltage change signal such as transition from high level to low level is present on the I/O port 42 of the control circuit 40. The voltage change signal is detected by the port-changed detection circuit, and in response thereto, the touchpad is waked up to restore to the normal operational mode from the power-saving mode. With the power-saving mechanism, the power consumption of the capacitive touchpad may be reduced to a minimum, while the response time for port-changed waking up is short and the touchpad is not required to be calibrated once more. The port-changed detection is well known in the art of microcontroller, and requires no additional cost. Preferably, the control circuit 40 is integrated in the microcontroller of the capacitive touchpad and installed on the printed circuit board 20, whereby the cost for hardware is never increased.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set fourth in the appended claims.

What is claimed is:

1. A structure of a capacitive touchpad, comprising:
a soft board having a bottom surface with a first conductor thereon;
a printed circuit board having a top surface with a second conductor thereon; and
a flexible insulator between the soft board and printed circuit board;
wherein a pressing on the soft board may move the first conductor down to contact the second conductor.

2. The structure of claim 1, wherein the first conductor comprises a mesh pattern thereof.

3. The structure of claim 1, wherein the soft board comprises a sandwich composed of multiple layers of conductor and insulator interlaced with one another.

4. The structure of claim 1, further comprising an electrical connection between the second conductor and an I/O port of a control circuit such that a voltage change signal is present on the I/O port when the first conductor contacts the second conductor.

5. A mechanism for power-saving of a capacitive touchpad including a soft board above a printed circuit board, the soft board having a first conductor facing to a second conductor on the printed circuit board, the mechanism comprising:
switching the capacitive touchpad to a power-saving mode when the capacitive touchpad is not in use;
generating a voltage change signal in response to a pressing of the soft board by moving the first conductor down to contact the second conductor; and
waking up the capacitive touchpad in response to the voltage change signal.
